(19) United States
(12) Patent Application Publication
(10) Pub. No.: US 2004/0058761 A1
(43) Pub. Date: Mar. 25, 2004

(54) Movable guide for transmission device formed by sandwich molding

(76) Inventor: Masahiko Konno, Osaka (JP)

Correspondence Address: George A. Smith, Jr., Box 457, Spring House, PA, 19477, US

(21) Appl. No.: 10/627,833

(22) Filed: Jul. 25, 2003

(30) Foreign Application Priority Data
Sep. 25, 2002 (JP) 2002-278976

(51) Int. Cl. F16H 7/08

(52) U.S. Cl. 474/111; 474/140

(57) ABSTRACT

In a movable guide for a transmission device, a slide rail extending in the direction of travel of a transmission chain, a pivotable rail support, and a plunger-contacting portion, are formed by sandwich molding a high-strength first polymer resin to form a core, and a second, wear-resistant polymer resin to form a skin layer entirely covering the core. The guide exhibits excellent mechanical strength and wear resistance, especially in its plunger-contacting portion, and is light in weight, inexpensive, and readily recycled.

### FIELD OF THE INVENTION

This invention relates to guides for endless, flexible, power transmission media such as roller chains, silent chains, and the like, which transmit power from a driving sprocket to one or more driven sprockets, for example, in the timing transmission of an internal combustion engine. More particularly, the invention relates to a movable guide which maintains tension by sliding contact with the traveling transmission medium.

### BACKGROUND OF THE INVENTION

In the timing transmission of an automobile engine or the like which utilizes a timing chain, the movable guide is usually pivotally mounted on the engine block, or on another suitable frame, by a mounting bolt, pin or the like. The guide cooperates with a tensioner, which maintains the guide in sliding contact with the chain and imparts appropriate tension to the chain to prevent transmission failure due to excess tension or excess loosening of the chain.

As shown in FIGS. 9 and 10, a movable guide 100 conventionally referred to as a “tensioner lever,” includes a resin shoe 101, on which the transmission chain slides, and an aluminum arm 102, which supports the shoe. The guide also includes a plunger-contacting resin pad 103, mounted on a part 102a of the aluminum arm 102. The guide of FIGS. 9 and 10 is described in Japanese Utility Model Registration No. 2540896 at pages 1 to 3 and in FIG. 1.

In the conventional tensioner lever 100, the resin shoe 101 and the aluminum arm 102 are secured together by a snap locking structure. Therefore, an assembly step requiring skilled labor is required. This assembly step is disadvantageous because it increases the cost of production of the guide. Moreover, the snap locking structure is susceptible to breakage, and consequently dissatisfaction has arisen because of insufficient reliability.

Furthermore, since the resin pad 103 is detachably mounted, biased contact between the pad 103 and the plunger of the tensioner can result in a concentration of stress at the location at which the pad 103 is mounted on part 102a of the arm 102. Consequently, the resin pad 103 readily became worn and was susceptible to deformation, and was therefore insufficiently durable. Additionally, the need for attachment of the resin pad to the aluminum arm contributed to increased manufacturing cost.

Still another troublesome problem encountered with the conventional tensioner lever was that, when a worn tensioner lever was to be replaced, it was necessary to disassemble the lever, and dispose of the several parts separately, in order to satisfy regulations pertaining to waste disposal and recycling.

Accordingly, among the objects of the invention are the solution to the above-mentioned problems encountered in the manufacture and use of conventional movable guides, and the provision of a light weight and inexpensive movable guide which can be easily produced by sandwich molding, which can be recycled conveniently, and which exhibits excellent mechanical strength and wear resistance in its plunger-contacting portion.

### SUMMARY OF THE INVENTION

The movable guide in accordance with the invention comprises an elongated slide rail for sliding engagement with a transmission medium, the direction of elongation of the slide rail extending along the direction of travel of the transmission medium. The guide also includes a support extending along the slide rail in the direction of elongation thereof, for supporting the slide rail. The support is pivotable adjacent one end thereof, and has a plunger-contacting portion adjacent its opposite end. The elongated slide rail, rail support, and plunger-contacting portion are sandwich-molded and comprise a unitary molded core composed of a first, high-strength polymer resin, and a second polymer resin forming a skin layer. Parts of the unitary molded core form interior parts of the rail, the rail support and the plunger-contacting portion. The skin layer is composed of a wear-resistant, second polymer resin, and entirely covers the outer surface of the core.

In a preferred embodiment, the plunger-contacting portion includes a side wall for limiting lateral shift of the guide relative to the plunger of a tensioner, the side wall extending along the direction of travel of the transmission medium.

The plunger-contacting portion preferably has an outer surface with an arc-shaped longitudinal cross-section, such that the plunger-contacting portion may be maintained in contact with the axial center of the plunger of a tensioner, as the plunger moves toward and away from a transmission medium in sliding engagement with the slide rail.

The plunger-contacting portion preferably has a convex shape and also has an arc-shaped cross-section transverse to the direction of elongation of the slide rail.

In a preferred embodiment, the first polymer resin is a glass fiber-reinforced polyamide 66 resin. The second polymer resin is preferably a polyamide 66 resin or a polyamide 46 resin.

As used herein, the term “plunger-contacting portion” refers to a region on the rail support, remote from the rail support pivot axis, which is adapted to be engaged by the plunger of a tensioner for imparting appropriate tension to a transmission medium. The plunger-contacting portion, which is continuous with the rail support may be of any desired shape so long as it does not interfere with the proper operation of the tensioner or cause the tensioner to assume a locked condition.

The term “sandwich molding” refers to a method of producing a molded product in which two kinds of polymer resin are simultaneously, or substantially simultaneously, injection-molding in a mold having a shape corresponding to the outer shape of the molded product. The product is sometimes known as a “skin-core, two-layer,” molded product. The sandwich molding method in accordance with the invention can be carried out using known sandwich molding injection-molding machines.

Although the known sandwich molding injection-molding machines are provided with various sandwich nozzles, a parallel type sandwich nozzle utilizing a torpedo (that is an injection switching member for switching between a skin polymer resin and a core polymer resin) is preferred for producing the guide in accordance with the invention. The torpedo is moved forward or backward so that the injection rate can be accurately controlled in accordance with the shape of the molded product.

The injection rate can determine the strength of the guide. For example, the strength of the guide can be improved by decreasing the thickness of the skin layer and increasing the volume of the core layer.

Although there is no particular limitation on the choice of the first and second polymer resins, it is preferred that they have chemical affinity, and that they have similar shrink characteristics because they are fused to each other in the process of sandwich molding. Preferred first and second polymer resin materials include polyamide resins selected from a polyamide 6 resin, a polyamide 66 resin, a polyamide 46 resin, all aromatic polyamide resins, glass fiber reinforced polyamide 66 resin and the like.

Since the slide rail, the rail support, and the plunger-contacting portion of the guide are formed from a high-strength polymer resin, and are integrally joined to one another in a fully fused condition, the guide in accordance with the invention exhibits durability superior to that of a guide composed of a conventional single material or a guide composed of mechanically joined members, and can maintain proper tension in a traveling transmission medium over a long period of time.

The second polymer resin, present as a skin layer covering the entire outer surface of the guide, not only contributes to improved wear resistance, but also serves as a reinforcement for the three guide components: the slide rail, the rail support and the plunger-contacting portion.

When a side wall, extending along the direction of travel of transmission medium, is formed on the guide in order to limit lateral shift of the guide relative to the plunger of the associated tensioner, even if the location of the contact between the plunger and the guide becomes shifted slightly as a result of snaking, which is liable to occur when the transmission medium travels at high speed, the side wall maintains a stable relationship between the plunger and the guide, even if the plunger comes out of contact with the guide.

When the plunger-contacting portion of the guide has an arc-shaped profile, i.e., an arc-shaped longitudinal cross-section, the plunger-contacting portion can be maintained in contact with the axial center of said plunger, while the plunger moves forward or backward relative to the transmission medium. Accordingly, even if a change of tension in the transmission medium cause the angle between the plunger axis and the longitudinal direction of the guide to change, the plunger-contacting portion remains stably in contact with the axial center of the plunger.

When the plunger-contacting portion has a convex shape, and has an arc-shaped cross-section transverse to the direction of elongation of the slide rail, even if the slide rail becomes inclined slightly in the direction of the width of the guide as a result of snaking, the plunger-contacting portion stably receives the plunger and remains in contact with the axial center of the plunger.

When the first polymer resin is a glass fiber-reinforced polyamide 66 resin, and the second polymer resin is a polyamide 66 resin or a polyamide 46 resin, the affinity between the two types of resin causes their boundary region to become a fully integrated, fused region, and the guide will accordingly exhibit improved durability.

### BRIEF DESCRIPTION OF THE DRAWINGS

FIG. 1 is a schematic, front elevational view of a timing transmission of an internal combustion engine, for explaining a typical use of the invention;

FIG. 2 is a perspective view of a movable guide in accordance with an embodiment of the invention;

FIG. 3 is an enlarged cross-sectional view taken on plane A-A in FIG. 2;

FIG. 4 is a cross-sectional view taken on plane B-B in FIG. 2;

FIG. 5 is fragmentary perspective view, partly in cross-section, of a movable guide in accordance with an embodiment of the invention, in which the plunger-contacting portion of the guide includes a lateral shift-limiting side wall;

FIG. 6 is a side elevational view of still another embodiment, having a concave plunger-contacting portion;

FIG. 7 is fragmentary perspective view, partly in cross-section, of a movable guide in accordance with an embodiment of the invention, in which the plunger-contacting portion has an arc-shaped transverse cross-section;

FIG. 8 is fragmentary perspective view, partly in cross-section, of a movable guide for comparison with the guide of FIG. 7;

FIG. 9 is an elevational view of a conventional movable guide; and

FIG. 10 is an exploded perspective view of the plunger-contacting portion of the guide of FIG. 9.

### DETAILED DESCRIPTION OF THE PREFERRED EMBODIMENTS

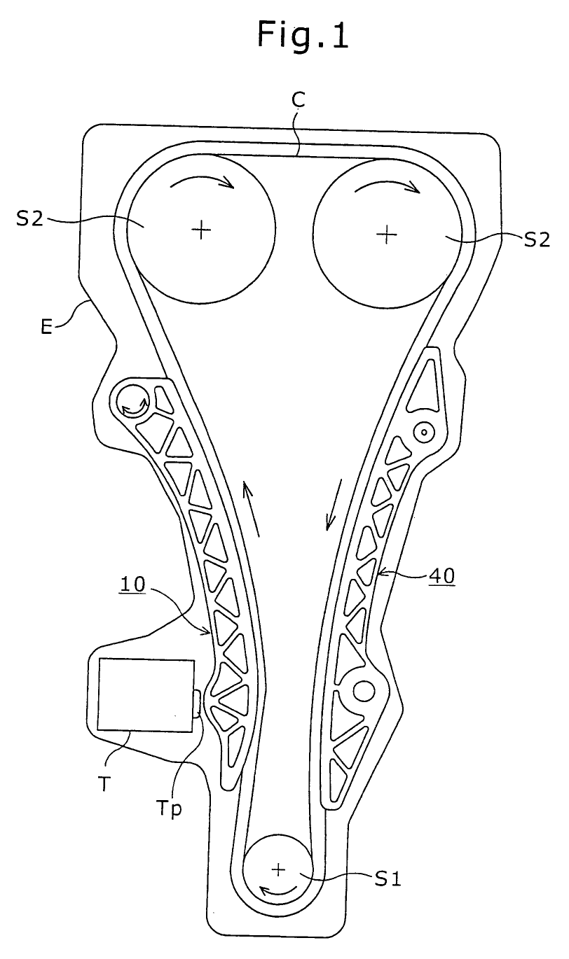

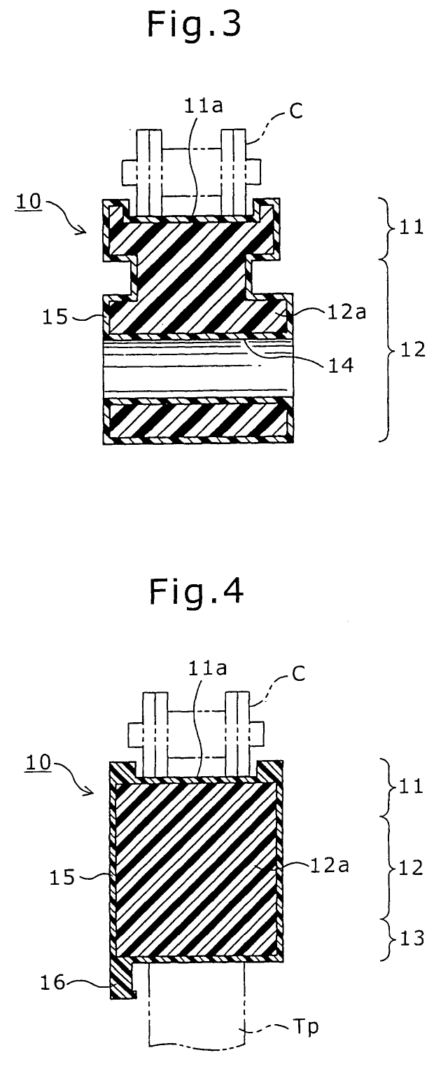

Preferred embodiments of a sliding contact guide according to the invention will be described below with reference to FIGS. 1 to 8.

As shown in FIG. 1, the movable guide 10 is incorporated in the timing transmission of an internal combustion engine E. A chain C, driven by a crankshaft sprocket S1 transmits power to camshaft sprockets. The guide 10 is in sliding contact with the return side of chain C, and serves a tensioner lever, cooperating with the plunger Tp of a tensioner T, to maintain tension in the chain. A fixed guide 40 is typically engaged with the driving side of the chain.

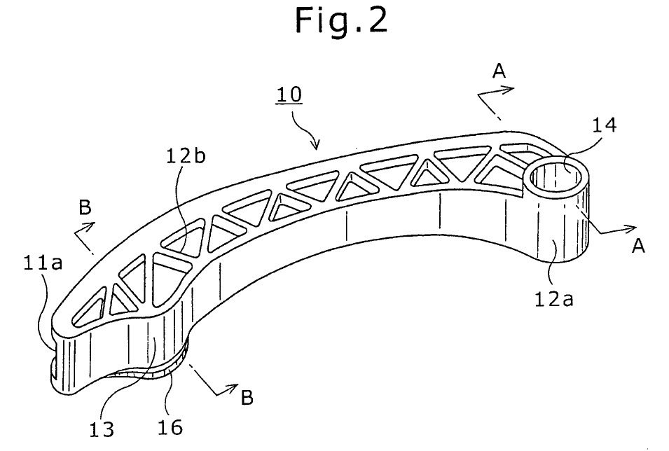

As shown in FIGS. 2-4, the movable guide 10 comprises a slide rail 11, elongated in the direction of travel of the transmission chain, and having an arc-shaped sliding contact surface 11a. The guide also has a rail support 12 extending perpendicularly from the rail 11 on the side opposite from the sliding contact surface 11a. The support is also elongated in the longitudinal direction of the rail. As shown in FIGS. 2 and 4, the guide also includes a plunger-contacting portion 13, adjacent one end of the support 12, for contact with a tensioner (see FIG. 1) for imparting proper tension to a chain. The rail support 12 includes a boss 12a having a mounting hole 14 for pivotal mounting on a bolt or pin (not shown) typically mounted on an engine block. As shown in FIG. 2, the guide is typically formed with an array of ribs 12b for reinforcement and weight reduction.

A first high strength polymer resin is used as the core material for the slide rail 11, the rail support 12, and the plunger-contacting portion 13. These parts of the core are unitary, so that the strength required in the high temperature environment within an automobile engine, can be maintained at a high level over a long period of time.

Although a glass fiber-reinforced polyamide 66 resin is preferred as the core material, various other polymer resins can exhibit high strength when used to impart tension to transmission chain C over a long period of time. For example, any polyamide, such as polyamide 46 resin, aromatic polyamide resin, or the like, can be used instead of polyamide 66.

A skin layer 15 is formed on the outer surface of the unitary core which composes the slide rail 11, the rail support 12 and the plunger-contacting portion 13. The skin layer 15 covers the entire core and forms the outer surface of the guide. A second high strength polymer resin material, such as polyamide 66 resin, may be used As the skin layer 15. This second polymer resin material is in sliding contact with the transmission chain C over a long period of time and is therefore required to exhibit good wear resistance. In addition to its superior wear resistance, the second polymer resin, by being integrally fused to the core as a skin, reinforces the slide rail 11, the rail support 12 and the plunger-contacting portion 13.

As shown in FIGS. 2 and 4, a lateral shift-limiting side wall 16 is provided along a side of the plunger-contacting portion 13. This side wall extends along the direction of travel of the transmission chain. The side wall 16 also preferably consists of a polyamide 66 resin. Even if the transmission chain C becomes slightly shifted laterally relative to the plunger as a result of snaking of the chain, the lateral shift-limiting side wall 16 stably receives the plunger, even if the plunger is temporarily out of contact with the plunger-contacting portion 13 of the guide. As a result, stable travel of the transmission chain C is ensured.

Polyamide 66 resin was preferred as the second polymer resin. However provided that the resin material exhibits wear resistance over a long period of time when in sliding contact with a transmission medium, a resin other than polyamide 66, for example a polyamide 46 resin, can be used as he second polymer resin.

To sandwich-mold the guide structure, a polyamide 66 resin is first injected, from a sandwich nozzle of a sandwich molding injection molding machine, into a single, and simple, mold having an internal shape corresponding to the desired outer shape of the guide. The resin first injected starts the molding of the skin layer 15 over the entire outer shape of the guide.

Then, at the same time, or at substantially the same time, as the start of injection of the skin layer 15, a glass fiber-reinforced polyamide 66 resin is injected to form the core layer. After the mold is cooled, the molded product is removed from the mold.

Since the skin layer 15, is formed over the entire outer surface of the unitary core, the rail, the rail support, and the plunger-contacting portion are more strongly joined to one another.

The surface layer portions of the boss 12a and the mounting hole 14, provided at one end of the rail support 12 for mounting the guide 10, are injection-molded with polyamide 66 resin. Accordingly, the guide can pivot smoothly as a result of the lubricating effect of the polyamide 66, and adapt to excessive tension or loosening of the transmission chain, so that proper chain tension can be maintained.

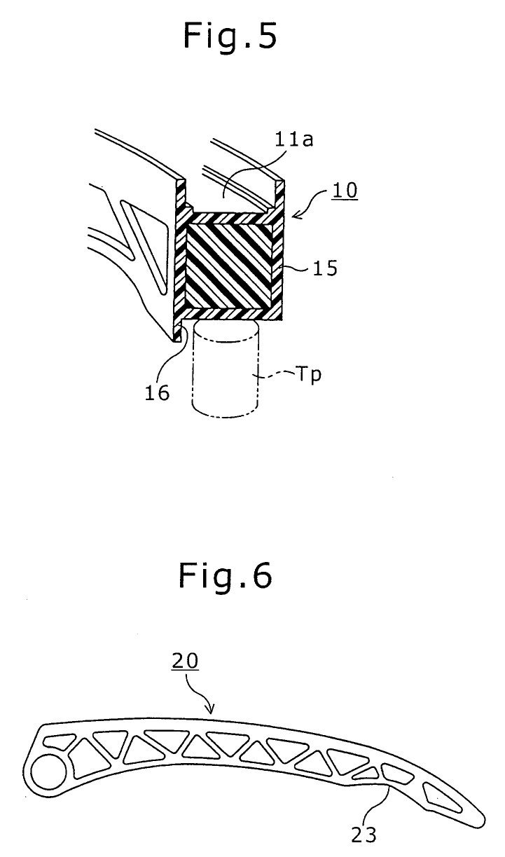

As shown in FIGS. 2 and 4, the plunger-contacting portion 13 includes a lateral shift-limiting side wall 16 formed along the direction of travel of the transmission chain. Thus, as shown in FIG. 5, even if the contact position between the plunger-contacting portion 13 and the plunger Tp is shifted slightly as a result of snaking, the lateral shift-limiting side wall 16 stably receives the plunger Tp, even while the tip of the plunger is out of contact with the plunger-contacting portion of the guide. As a result, stable travel of the transmission chain is ensured.

Further, as shown in FIG. 2, the plunger-contacting portion 13 has an arc-shaped profile, which remains in contact with the axial center of the plunger Tp, as the plunger moves forward or backward. Accordingly, even while the guide pivots in accordance with a change in tension in the transmission chain C, so that the contact angle of the plunger Tp with respect to the longitudinal direction of the guide changes, the plunger-contacting portion 13 stably engages the plunger Tp. As a result, stable travel of the transmission chain along the longitudinal direction of the guide is ensured.

The movable guide shown in FIG. 6 is a modified example of the invention, in which the plunger-contacting portion 23 has a concave, arc-shaped profile. This plunger-contacting portion also remains in contact with the axial center of the plunger Tp. The effects of the plunger-contacting portion 23 are the same as those of the above-described plunger-contacting portion 13.

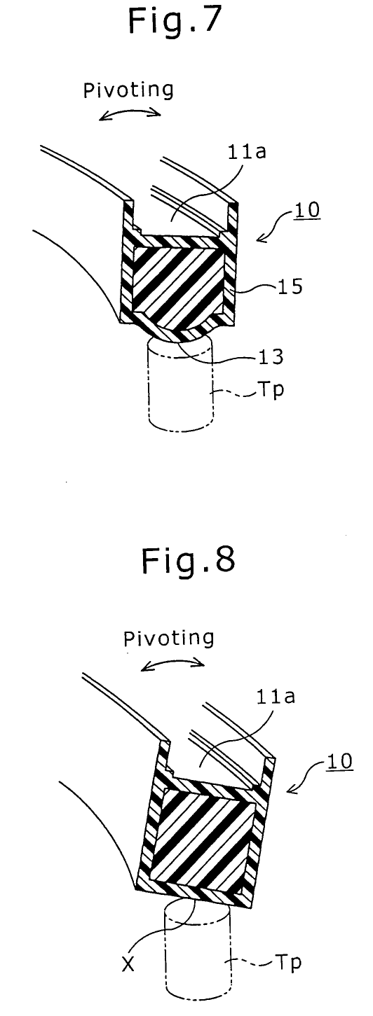

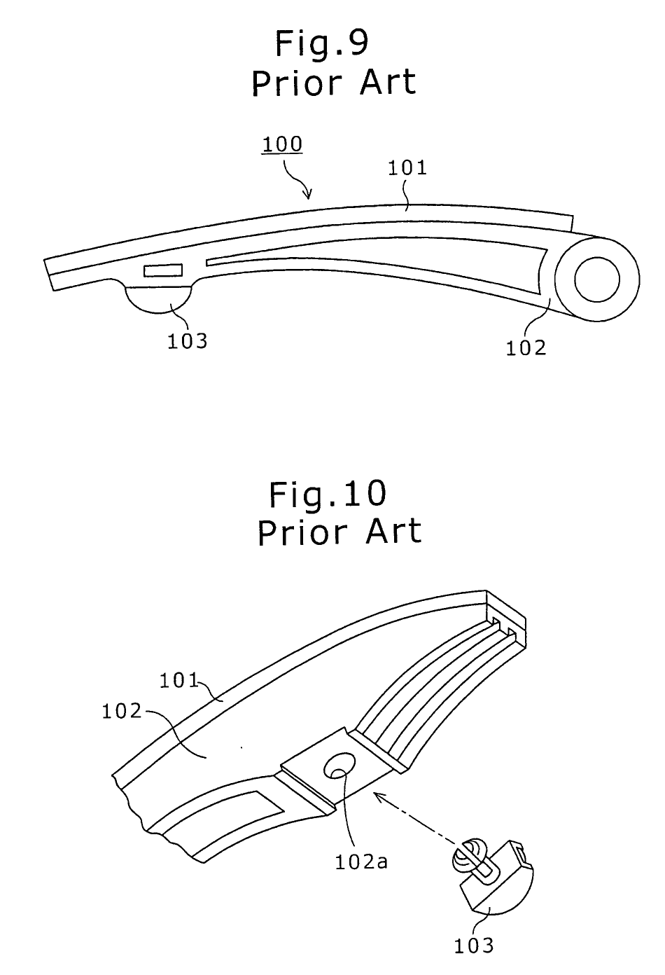

The plunger-contacting portion 13 may also have a convex, arc-shaped transverse cross-section, bulging toward the plunger Tp, as shown in FIG. 7. With the plunger-contacting portion shaped in this manner, even if the slide rail 11 becomes slightly inclined in the direction of the width of the guide as a result of snaking, the plunger-contacting portion 13 stably receives the plunger Tp and always contacts the axial center of the plunger Tp. As a result, stable travel of the transmission chain in the direction of the width of the guide can be ensured without generating the biased contact condition shown at X in FIG. 8. resulting from rolling of the transmission chain.

Since the entire movable guide 10 for the transmission device consists of a polymer resin, reduction in the weight of the guide can be realized, and the guide can be easily recycled without disassembly and separation of its components after removal it from an engine.

The following beneficial results may be realized from the invention.

First, as compared with a conventional movable guide, which is formed of mechanically connected members, the guide in accordance with the invention exhibits excellent wear resistance and durability especially in the plunger-contacting portion. Furthermore, since the surface layer portions of the boss and the mounting hole adjacent one end of the rail support are injection-molded with the second, wear-resistant polymer resin, the guide can pivot smoothly and adapt to excessive tensioning or loosening of the chain, so that proper chain tension can be maintained.

Furthermore, since the slide rail, the rail support, and the plunger-contacting portion are integrally molded as a unit by sandwich molding, the molding of the slide rail, the molding of the rail support, the molding of the plunger-contacting portion, the assembly and integration of the slide rail and the rail support, and the assembly and integration of the rail support and the plunger-contacting portion, are substantially automatically performed in a single step. Thus, unlike the conventional case, special molds are not needed for the production of the movable guide of the invention. Moreover, complicated production steps can be simplified, and the molding cycle time can be decreased. As a result, the production cost of a movable guide is significantly reduced. Furthermore, since the movable guide for the transmission device of the invention does not require a steel-sheet core material as used in a conventional movable guide, the weight of the guide is reduced, improved fuel efficiency can be realized in an internal-combustion engine, and vibration noise is reduced by suppression of vibration energy.

By the use of sandwich molding, in which two kinds of molten polymer resin are simultaneously, or substantially simultaneously, injected, and merge with each other in a fully fused condition, the first and second polymer resin materials can be selected in accordance with wear resistance requirements, and high strength properties needed under the temperature conditions inside an automobile engine or the like. The polymer resins can also be optionally selected in to provide sliding properties needed to accommodate a particular transmission chain. Additionally, since the entire guide is composed of two kinds of polymer resin, the entire guide can be recycled, after removal from a transmission device. without disassembly and separation of materials,

With the lateral shift limiting side wall formed along the direction of travel of the transmission chain, even if the position of contact between the guide and the plunger of a tensioner becomes shifted slightly as a result of snaking, the shift-limiting side wall stably engages the plunger. As a result, stable travel of the transmission chain can be ensured.

Where the plunger-contacting portion has an arc-shaped profile, it can remain in contact with the axial center of the plunger as the plunger moves forward and backward. Accordingly, even if the contact angle of the plunger with respect to the longitudinal direction of the guide changes, the plunger-contacting portion stably engages the plunger at the axial center of the plunger. As a result, stable travel condition of the transmission chain along the longitudinal direction of the plunger can be ensured.

Where the plunger-contacting portion has a convex, arc-shaped transverse cross-section, even if the slide rail becomes slightly inclined in the direction of the width of the guide as a result of snaking, the plunger-contacting portion stably engages the plunger while remaining in contact with the axial center of the plunger. This feature also contributes to stable travel condition of the transmission chain.

Where the first polymer resin material is a glass fiber-reinforced polyamide 66 resin, and said second polymer resin material is a polyamide 66 resin or a polyamide 46 resin, the affinity between the first and second polymer resins allows them to be fully fused and integrated with each other at their boundary region. Thus the guide can exhibit excellent durability.

I claim:

1. A movable guide for an endless, flexible power transmission medium comprising an elongated slide rail for sliding engagement with the transmission medium with the direction of elongation of the slide rail extending along the direction of travel of said transmission medium, a support extending along the slide rail in the direction of elongation thereof, for supporting said slide rail, said support being pivotable adjacent one end thereof, and having a plunger-contacting portion adjacent an opposite end thereof, said elongated slide rail, said rail support, and said plunger-contacting portion being sandwich-molded and comprising a unitary molded core composed of a first, high-strength polymer resin, parts of said unitary molded core forming interior parts of said rail, said rail support and said plunger-contacting portion, and a skin layer composed of a wear-resistant, second polymer resin, said skin layer entirely covering the outer surface of said core.

2. A movable guide according to claim 1, in which said plunger contacting portion includes a side wall for limiting lateral shift of the guide relative to the plunger of a tensioner, said side wall extending along the direction of travel of said transmission medium.

3. A movable guide according to claim 1, in which said plunger-contacting portion has an outer surface with an arc-shaped longitudinal cross-section, whereby the plunger-contacting portion may be maintained in contact with the axial center of the plunger of a tensioner, as the plunger moves toward and away from a transmission medium in sliding engagement with the slide rail.

4. A movable guide according to claim 2, in which said plunger-contacting portion has outer surface with an arc-shaped longitudinal cross-section, whereby the plunger-contacting portion may be maintained in contact with the axial center of the plunger of a tensioner, as the plunger moves toward and away from a transmission medium in sliding engagement with the slide rail.

5. A movable guide according to claim 1, characterized in that said plunger-contacting portion has a convex shape and has an arc-shaped cross-section transverse to the direction of elongation of the slide rail.

6. A movable guide according to claim 2, characterized in that said plunger-contacting portion has a convex shape and has an arc-shaped cross-section transverse to the direction of elongation of the slide rail.

7. A movable guide according to claim 3, characterized in that said plunger-contacting portion has a convex shape and has an arc-shaped cross-section transverse to the direction of elongation of the slide rail.

8. A movable guide according to claim 4, characterized in that said plunger-contacting portion has a convex shape and has an arc-shaped cross-section transverse to the direction of elongation of the slide rail.

9. A movable guide according to claim 1, in which said first polymer resin is a glass fiber-reinforced polyamide 66 resin, and said second polymer resin is a polyamide 66 resin or a polyamide 46 resin.

10. A movable guide according to claim 2, in which said first polymer resin is a glass fiber-reinforced polyamide 66 resin, and said second polymer resin is a polyamide 66 resin or a polyamide 46 resin.

11. A movable guide according to claim 3, in which said first polymer resin is a glass fiber-reinforced polyamide 66 resin, and said second polymer resin is a polyamide 66 resin or a polyamide 46 resin.

12. A movable guide according to claim 4, in which said first polymer resin is a glass fiber-reinforced polyamide 66 resin, and said second polymer resin is a polyamide 66 resin or a polyamide 46 resin.

13. A movable guide according to claim 5, in which said first polymer resin is a glass fiber-reinforced polyamide 66 resin, and said second polymer resin is a polyamide 66 resin or a polyamide 46 resin.

14. A movable guide according to claim 6, in which said first polymer resin is a glass fiber-reinforced polyamide 66 resin, and said second polymer resin is a polyamide 66 resin or a polyamide 46 resin.

15. A movable guide according to claim 7, in which said first polymer resin is a glass fiber-reinforced polyamide 66 resin, and said second polymer resin is a polyamide 66 resin or a polyamide 46 resin.

16. A movable guide according to claim 8, in which said first polymer resin is a glass fiber-reinforced polyamide 66 resin, and said second polymer resin is a polyamide 66 resin or a polyamide 46 resin.
